(19) United States
(12) Patent Application Publication
(10) Pub. No.: US 2025/0096511 A1
(43) Pub. Date: Mar. 20, 2025

(54) PLUG CONNECTOR SYSTEM AND ELECTRICAL POWER DISTRIBUTION SYSTEM

(71) Applicant: HARTING ELECTRIC STIFTUNG & CO. KG, Espelkamp (DE)

(72) Inventor: Sebastian GRIEPENSTROH, Lübbecke (DE)

(21) Appl. No.: 18/824,737

(22) Filed: Sep. 4, 2024

(30) Foreign Application Priority Data
Sep. 14, 2023 (DE) 10 2023 124 873.1

(51) Int. Cl. H01R 13/703

(52) U.S. Cl. CPC H01R 13/7032

(57) ABSTRACT

A plug connection system and electrical coding system is provided for direct current supply—for example of an electric agricultural machine—on the one hand rotatable to an unlimited extent about the mating axis, but on the other hand also provides a coding for reverse polarity protection and at the same time prevent pulling and plugging under load, configured to clearly signal for each of the plug connectors, regardless of the plug connector's respective rotational position, whether the respective plug connector is correctly plugged in with the plug connector's corresponding panel plug connector. The plug connector can have a circumferential short-circuit bridge and the panel plug connector can have two signal contacts, which, in the correctly mated state, are short-circuited by the short-circuit bridge, regardless of the rotational state of the plug connector relative to the panel plug connector. The coding can be provided via the position and shape of the signal contacts and the short-circuit bridge.

### BACKGROUND

### Technical Field

The present disclosure relates to a plug connector system.

The present disclosure also relates to an electrical power distribution system including a plug connector system.

Such plug connector systems and power distribution systems are required, among other things, to operate a flexible and possibly mobile power supply, e.g., a mobile power supply system for electric agricultural machinery, e.g., by a rechargeable battery, i.e., an accumulator. Alternatively, or additionally, accumulators arranged in accumulator racks, for example, can also be operated as accumulator packs in combination.

### Description of the Related Art

Battery columns, accumulator cabinets and accumulator racks in which several batteries are connected in parallel and/or in series by several patch cables in order to adapt their current and output voltage to the respective requirements are known in the prior art. Electric agricultural machinery which may require a mobile electrical power supply is also known.

The publications DE 10 2015 105 482 B4 and US 2018/0358789 A1 describe the basic structure of a switch cabinet or accumulator rack.

The publication EP 2 176 901 B1 shows an accumulator for hand-held, electromechanical tools, with a plurality of accumulator cells which are electrically fixedly connected to each other by several electrical cell connectors.

Publication DE 10 2016 124 501 A1 discloses a battery management system for a configurable accumulator pack.

Based on this, the publication DE 10 2020 132 965 A1 proposes a high-current connector that has an intuitive and downward-compatible coding for labelling its current-carrying capacity. The solution is a high-current connector of which the coding is formed by the depth of the contact hole. This prevents patch cables with a current-carrying capacity that is too low from being overloaded due to mis-mating.

A disadvantage of this prior art is that, due to the particular rigidity of the electrical power transmission cables used in this field, there is still no sufficiently convenient reverse polarity protection for the single-terminal plug connectors in particular. The power transmission cables can, for example, have a solid conductor or be stranded, which has an effect on their rigidity. They can also have thicknesses of at least 10 mm², in particular at least 20 mm², preferably at least 40 mm², particularly preferably 80 mm², in particular 100 mm², for example at least 150 mm² and—e.g., in the railway sector—even more.

Due to this high rigidity of the power cables, the orientation of the plug connector is usually already predetermined. A disadvantage of the prior art is therefore that conventional coding makes mating impossible in many cases, as it already specifies an orientation of the plug connector that does not correspond to the cabling conditions.

Without coding, however, there is no reverse polarity protection. If, due to a lack of reverse polarity protection, two plug connectors intended for connection to a positive or negative terminal of a battery/battery system are reversed, this may not only cause considerable damage to the connected electrical machines, e.g., the aforementioned electric agricultural machinery, but may also pose a risk to life and limb. This is another reason why automatic reverse polarity protection is particularly important.

To further prevent so-called “pulling under load,” i.e., disconnection of the plug contacts during electrical power transmission, the so-called HV (“high-voltage”) interlock is known in the prior art. The HV interlock monitors the correct connection of plug connections in the high-voltage circuit with the aim of preventing an electrical hazard due to unintentional, improper or otherwise caused disconnection of an HV plug connection when the HV system is active. To achieve this, the HV system has a so-called pilot or safety line. This is a series circuit to which 12 V on-board voltage is applied and which runs from HV plug connection to HV plug connection. If the circuit of the pilot line is interrupted by disconnecting one of the plug connections and the resulting disconnection of the pilot contacts in the plug, this is recognized by an HV control unit. As a result, the control unit immediately opens the main HV relays and de-energizes the system.

However, there is the aforementioned problem that the plug connectors must be in a certain rotational position for mating with plug-compatible panel plugs so that the corresponding signal contacts of said pilot line can come into electrical contact with each other. Usually, however, the plug connectors are connected to the aforementioned, particularly strong electrical power transmission cables, which are characterized by the aforementioned particularly high mechanical rigidity and therefore allow no or only very little torsion. In practice, this considerably impairs the use of conventional electrical and/or mechanical coding, in particular the HV interlock, or even makes their use impossible in many cases.

The publication DE 10 2018 127 720 B3 shows a high-current plug connector that can be mechanically coded as a panel plug connector for use with a specific mating plug connector and can be flexibly and conveniently adapted to the conditions of a confined installation space in which it is used. For this purpose, its insulating body is held on the pin contact so that it can rotate about the pin axis. This means that an angled plug connector plugged in and coded and aligned with it can be held rotatably so that its angled cable outlet can be flexibly aligned within the installation space as required.

However, such a plug connector is mechanically complex and therefore cannot be used in every situation. In particular, it can only be combined with the aforementioned HV interlock system to a limited extent, e.g., to prevent pulling under load, because the wiring of the HV interlock system restricts its ability to rotate.

### BRIEF SUMMARY

The present disclosure provides a plug connector system for an electrical power distribution system that offers reverse polarity protection that is as convenient to use as possible, even when using the aforementioned rigid power transmission cables. The plug connector system is also intended to avoid or at least minimize additional costs in the manufacture of the plug connector system compared to existing systems. An additional problem addressed is to specify a power distribution system that is easy to install and easy to handle and provides reliable protection against mis-mating, such as against reverse polarity.

A plug connector system described herein is intended for an electrical power distribution system.

The plug connector system has two plug connectors, namely a first and a second plug connector, each of which has a mating area and a cable outlet. For example, these two plug connectors can each be connected to an electrical power transmission cable on the connection side, e.g., to supply an electrical device, such as an electric agricultural machine, with electrical power.

The plug connector system also has two panel plug connectors, namely a first panel plug connector and a second panel plug connector, which are used to connect to one terminal of a battery or battery system—or alternatively to two terminals of any other direct current source.

The first panel plug connector is intended for plug-in electrical connection to said first plug connector, i.e., the first panel plug connector corresponds to the first plug connector. This mating process may take place in a first plug-in direction.

The second panel plug connector is intended for plug-in electrical connection with said second plug connector, i.e., the second panel plug connector corresponds with the second plug connector. This mating process may take place in a second plug-in direction.

In some embodiments, the first and second plug-in directions may run parallel to each other, depending on the installation situation of the panel plug connectors.

However, each of said plug connectors may be mechanically plugged into each of said panel plug connectors and may be electrically conductively connected when plugged in. Mis-mating is therefore also possible, i.e., the first panel plug connector can be mated with the second plug connector and the second panel plug connector can be mated with the first plug connector in the form of a mis-mating and can be electrically conductively connected in the plugged state.

In the plugged state, the respective plug connector can be rotated into various rotational positions about an axis of rotation running in the respective plug-in direction and/or the respective plug connector can be mated with the respective panel plug connector in a state rotated about the mating axis as desired.

The plug connector system has an electrical coding system.

This coding system is set up to clearly signal for each of the plug connectors, regardless of its respective rotational position, whether the respective plug connector is correctly mated with its corresponding panel plug connector.

Here and in the following, a person skilled in the art understands the term “correctly mated” to mean that the respective plug connector is mechanically and electrically conductively connected to its corresponding panel plug connector as intended for the desired electrical power transmission. In some embodiments, the plug connector may be latched and/or locked in its final mating position on the panel plug connector.

An electrical power distribution system has such a plug connector system, as well as a battery or a battery system with two terminals, namely a positive terminal and a negative terminal, between which, for example, an electrical supply voltage is applied, and at least two electrical power transmission cables, as well as at least one electrically switchable electrical switch, for example a relay, wherein the electrical switch has an input, an output and a control input.

The switch is designed to electrically connect or disconnect its output to or from its input in accordance with an electrical signal applied to its control input.

For this purpose, the control input may have two electrical control connections and the control signal in question may be a short circuit. This short circuit of the two control connections of the control input can be created by correctly plugging the respective connector/connectors into the corresponding panel plug connector. In some embodiments, the signal contacts of several panel plug connectors may be electrically connected in series or in parallel, depending on the desired function. However, it is preferable to connect the signal contacts of both panel plug connectors in series in order to ensure that they must be correctly plugged to both plug connectors so that the electrical switch, such as the relay, closes.

The input of the electrical switch is electrically conductively connected to one of the terminals of the battery, namely a positive or negative terminal.

At least one of the panel plug connectors is connected to the output of the electrical switch on the connection side.

Each of the plug connectors is connected to one of the power transmission cables on the cable connection side.

The power distribution system is set up to close the at least one electrical switch when the coding system signals that each panel plug connector is correctly mated with its corresponding plug connector.

This has the advantage that the electrical power supply is only automatically “switched on” when the plug connectors are correctly plugged with the panel plug connectors. The term “switched on” in this case means that the two electrical power supply cables are connected to the electrical power supply, i.e., one of the two electrical power supply cables is electrically conductively connected to the positive terminal and the other power supply cable is electrically connected to the negative terminal, e.g., the battery, in order to electrically operate the electrical device connected to it, e.g., the agricultural machine.

In some embodiments, an advantage is that the power supply is not even switched on if the polarity is “reversed.” Such a polarity reversal could occur, for example, if the first plug connector was plugged into the second panel plug connector and the second plug connector was plugged into the first panel plug connector. In this case, the at least one electrical switch would not close, the circuit would not be closed and the electrical power supply would not take place.

In some embodiments, it is also advantageous that the automation of the switch-on process also makes it possible to avoid both plugging and unplugging of the connectors under load. Lastly, the power supply is interrupted if the plug connector is not yet or no longer correctly plugged in. The corresponding signaling can be leading when the plug connector is removed from the panel plug connector and trailing when the plug connector is plugged into the panel plug connector in order to avoid removal or insertion under load. This means that the switch-on process can be delayed when plugging in and the switch-off process can be delayed when unplugging. This prevents arcing, sparks, etc., which has a favorable effect on the service life of the contacts.

The coding device has an advantageous dual function. After all, on the one hand it provides the aforementioned prevention of pulling and/or plugging under load and on the other hand it provides effective protection against the aforementioned incorrect plugging by electrical coding.

In one embodiment, the two electrical power transmission cables may belong to an electrical appliance, e.g., an electric agricultural machine, to the electric motor of which they are permanently connected, e.g., to the connections of which they are permanently screwed.

In one embodiment, in addition to the plug connector connected to a first end of each of the power transmission cables, a further plug connector on the device side may be connected to a second end of the power transmission cable. This plug connector on the device side is intended to be plugged into a further panel plug connector on the device side of the electrical device, such as the agricultural machine. In this case, the power distribution system can have a complete additional plug connector system on the device side, which is constructed in the same way as the aforementioned plug connector system. This can also advantageously prevent mis-mating on the device side or, in the event of mis-mating, can prevent the transfer of electrical energy to the electrical device. All electrical switches, such as the relays, on both the battery and the device side only close and the circuit is only completely closed when the battery and device are correctly connected, i.e., the electrical energy is only transferred from the battery/battery system to the electrical device, such as the agricultural machine, when both sides are correctly connected.

In one embodiment, the plug connector system may be used within an accumulator pack to connect several batteries/accumulators in parallel or in series, depending on requirements, and to prevent mis-mating. If an accumulator pack is intended for its batteries to be connected in parallel, a series connection can be prevented, for example.

In one embodiment, the plug connectors may be angled plug connectors.

The term “angled plug connectors” refers here to connectors of which the cable connection area is angled to the mating axis of the mating area by an outlet angle that is greater than 0°, wherein this angle can ideally be 90°, but in many cases is between 85° and 95°, for example. In principle, however, this outlet angle can also assume a value between 0° and 95°, preferably between 5° and 95°, such as between 5° and 90°, for example between 40° and 50° or between 25° and 40° or between 40° and 50°.

An advantage is that the electrical coding allows the plug connector to be rotated about its mating axis when plugged in without impairing its function.

In one embodiment, each of the plug connectors may be rotated endlessly, i.e., through 360°, to any desired rotational position when plugged in. This simplifies handling considerably. It is also advantageous that no consideration needs to be given to any existing control lines.

It is also advantageous that the plug connectors can be plugged in in the direction specified by their respective power transmission cable. The energy transmission cables can, for example, have a solid conductor or at least can be stranded, which has an effect on their rigidity. They can also have thicknesses of at least 10 mm², such as at least 20 mm², preferably at least 40 mm², preferably 80 mm², such as 100 mm², for example at least 150 mm² and—e.g., in the railway sector—even more. It is easy to imagine that the cable thickness impairs the flexibility of the alignment, e.g., already when wiring an accumulator pack, such as not allowing any significant torsion, so that it is advantageous if the plug connector can be rotated accordingly with respect to its corresponding panel plug connector and/or can be mated with its corresponding panel plug connector in the rotated state.

The present disclosure described herein is particularly advantageous for such angled plug connectors because their rotatability in the mated state ensures that the respective cable outlet can be rotated manually in a targeted and intuitive manner with only little effort in a direction in which the power cables extending from it do not obstruct each other. This can be a particular advantage when using patch cables, e.g., for the aforementioned cabling of accumulator racks.

However, even if the plug connectors are non-angled plug connectors, which are distinguished by the fact that their cable connection area forms an angle of 0° to the mating axis of the plug connector within the framework of the manufacturing tolerances, said rotatability and/or pluggability in any state rotated about the mating axis is of particular advantage. Lastly, the cable route is usually largely predetermined by the external conditions. As already mentioned in detail, the large cable thickness of the electrical power transmission cables does not allow any significant torsion, so that the rotational position is largely predetermined by the arrangement of the cable and by the other conditions, such as the cabling. For example, in the aforementioned battery rack/accumulator rack, i.e., a rack in which several batteries/accumulators are arranged on top of each other and are electrically connected in series and/or parallel by several patch cables, the direction of rotation of each plug connector can already be largely predetermined by the course of the respective patch cable.

In one embodiment, the plug connectors and panel plug connectors may be designed to transmit electrical energy with an electrical current of more than 20 A (“amperes”) and/or an applied electrical voltage of more than 50 V each.

In one embodiment, each plug connector may be designed with a single terminal and has exactly one electrically conductive energy transfer contact. The respective panel plug connector is then also of single-terminal design, i.e., it has exactly one mating contact for plug-in electrical connection with the exactly one power transmission contact of the corresponding plug connector for the purpose of transmitting electrical power to the respective plug connector.

In a further embodiment, each of the plug connectors may have an insulating body with an at least partially cylindrical plug-in opening. Thus, the first plug connector has a first plug-in opening and the second plug connector has a second plug-in opening. The coding system can then have a circumferential electrically conductive short-circuit bridge on the inside of each plug-in opening, namely a first short-circuit bridge in the first plug-in opening of the first plug connector and a second short-circuit bridge in the second plug-in opening of the second plug connector. In some embodiments, each insulating body may be substantially hollow-cylindrical in shape, i.e., can also have a cylindrical outer contour, in order to enable or facilitate said rotatability.

In a further embodiment, the plug connectors may be substantially identical to one another and can differ from one another substantially only in the shape and position of the respective short-circuit bridges, which are arranged in their respective plug-in openings.

In some embodiments, each of the short-circuit bridges may be hollow-cylindrical and has a cylinder axis. Each short-circuit bridge has a height to be measured in the direction of the cylinder axis. In addition, each short-circuit bridge has a plug-in-side end and a cable-connection-side end. At its plug-in-side end, each short-circuit bridge has a plug-in-side edge. At its cable-connection-side end, the short-circuit bridge has a cable-connection-side edge. The cable-connection-side edge is spaced from the plug-in-side edge of this short-circuit bridge by the respective height.

In some embodiments, the height of the first short-circuit bridge may be less than the height of the second short-circuit bridge. In one embodiment, the height of the first short-circuit bridge may be at least 1.5 mm (“millimeters”) less than the height of the second short-circuit bridge. In one embodiment, the height of the first short-circuit bridge may be at least 2.5 mm less than the height of the second short-circuit bridge. In some embodiments, the height of the first short-circuit bridge may be at least 5 mm less than the height of the second short-circuit bridge. For example, the height of the first short-circuit bridge may be at least 7.5 mm less than the height of the second short-circuit bridge. For example, the height of the first short-circuit bridge may even be at least 10 mm (“millimeters”) less than the height of the second short-circuit bridge.

In a further embodiment, the plug-in-side edge of the second short-circuit bridge may be arranged deeper in the plug-in opening of the second plug connector than the plug-in-side edge of the first short-circuit bridge in the plug-in opening of the first plug connector.

Both of the above-mentioned feature complexes are advantageously used to clearly identify the plug connectors from the panel plug connectors by their short-circuit bridges.

In a further embodiment, the coding system may have two signal contacts for each panel plug connector in order to clearly signal to a connected power distribution system whether the panel plug connector is correctly mated with its corresponding plug connector by a short circuit of these two signal contacts via the respective short-circuit bridge. The signal contacts can advantageously loop along the inside of the respective short-circuit bridge during rotation and thus enable the aforementioned rotatability, such as through 360°.

The two signal contacts can, for example, be arranged on two different—suchas two opposite—sides of the respective mating area of the respective panel plug connector.

In one embodiment, the two signal contacts may be resilient and in particular can consist of resilient sheet metal.

In one embodiment, the two signal contacts of each panel plug connector may each be connected to the control input of an electrical switch, such as a relay, wherein the electrical switch electrically connects the respective panel plug connector to the respective terminal of the battery when closed. However, a total of two electrical switches are then required for the two panel plug connectors alone.

In order to manage with only one electrical switch for both panel plug connectors for economic reasons, the two signal contacts of both panel plug connectors may be electrically connected in series with each other and with the control input of only one electrical switch, such as a relay, in one embodiment. Both signal contact pairs must then be short-circuited so that there is a short circuit at the control input of one electrical switch and the electrical switch closes. This electrical switch can be located selectively on either of the two panel plug connectors. It only needs to interrupt the circuit at one point if one of the two plug connectors is not correctly connected to the respective panel plug connector.

Such a series connection can be realized as follows, for example: The first control connection of the control input of the electrical switch is electrically conductively connected to the first signal contact of the first panel plug connector. The second signal contact of the first panel plug connector is electrically conductively connected to the first signal contact of the second panel plug connector. The second signal contact of the second panel plug connector is electrically conductively connected to the second control connection of the control input of the electrical switch.

In one embodiment, the signal contacts of the second panel plug connector may be arranged offset from each other in the second plug-in direction on the mating area of the second panel plug connector. In some embodiments, the two signal contacts of the second panel plug connector may be arranged offset in the second mating direction by more than the height of the first short-circuit bridge on the mating area of the second panel plug connector. In order to ensure good functional reliability, the two signal contacts of the second panel plug connector can be offset from each other in the second plug-in direction by at least the height of the first short-circuit bridge plus a “delta” value in the mating area of the second panel plug connector. In some embodiments, this delta may be at least 1 mm (“millimeter”), preferably at least 2 mm, such as at least 4 mm and at least 6 mm, e.g., 8 mm or even more, e.g., even 10 mm or even more.

On the other hand, the two signal contacts of the first panel plug connector can either not be arranged at all in the first plug-in direction or offset by a maximum of the height of the first short-circuit bridge—i.e., only by the height of the first short-circuit bridge or by less than the height of the first short-circuit bridge—at the mating area of the first plug connector.

In one embodiment, in a possible mis-mated state of the first plug connector with the second panel plug connector, none—or at most only one—of the signal contacts arranged in the first panel plug connector may extend deep enough into the plug-in opening of the second plug connector to be able to make electrical contact with the second short-circuit bridge. This means that no short circuit can occur between the signal contacts.

The two signal contacts arranged in the first panel plug connector can only be short-circuited by the first short-circuit bridge of the first plug connector, as the second short-circuit bridge is arranged too deep in the plug-in opening of the second plug connector to connect these two signal contacts electrically conductively.

It is advantageous if the two signal contacts arranged in the second panel plug connector are only short-circuited by the second short-circuit bridge, as the first short-circuit bridge—even in the event of a corresponding mis-mating—is too low. This also prevents these two signal contacts from being electrically conductively connected during the mating process—even if only temporarily—i.e., short-circuited at least briefly during the mating process.

The two signal contacts arranged in the first panel plug connector, on the other hand, can advantageously be short-circuited by the first short-circuit bridge when correctly plugged into the first plug connector, as they are close enough together—when viewed in the first plug-in direction—to make simultaneous electrical contact with the first short-circuit bridge when plugged in.

The two signal contacts arranged in the second panel plug connector can be short-circuited by the second short-circuit bridge when correctly mated with the second plug connector, since—viewed in the second mating direction—they are inserted deep enough into the mating opening of the second plug connector to simultaneously make electrical contact with the first short-circuit bridge when mated.

In one embodiment, the energy distribution system may close the respective electrical switch, such as the respective relay, precisely when the two signal contacts of the respective panel plug connector are short-circuited. For this purpose, the power distribution system can, for example, apply a preferably low measurement voltage of, for example, only a few volts, e.g., 1 to 20 V (“volts”), e.g., 12 V (“on-board voltage”), to the two signal contacts and then measure whether a current flows through the signal contacts in order to determine the short circuit.

If there is a short circuit, the respective plug connector is correctly plugged with the corresponding panel plug connector.

For example, the first plug connector can be connected to the positive terminal of the battery via the first panel plug connector. As soon as a correct plug connection is established between the first plug connector and the first panel plug connector, the signal contacts of the first panel plug connector are short-circuited.

The second plug connector may be connected to the negative terminal of the battery via the second panel plug connector. As soon as a correct plug connection is established between the second plug connector and the second panel plug connector, the signal contacts of the second panel plug connector are short-circuited.

If the first and second plug connectors are plugged in correctly, the series connection of the signal contacts of both panel plug connectors also provides a short circuit. In this way, a single electrical switch, e.g., a single relay, can be used to close a circuit depending on the correct plug-in status of both plug connectors. In addition to the battery and the plug-in system, the circuit can also include a consumer connected to the cable side, e.g., the aforementioned electric agricultural machine.

### BRIEF DESCRIPTION OF THE SEVERAL VIEWS OF THE DRAWINGS

FIG. 1 shows a prior-art panel plug with an HV interlock connection.

FIG. 2a shows a first plug connector with a power transfer contact and a circumferential short-circuit bridge.

FIG. 2b shows a first panel plug connector with a mating contact and two signal contacts.

FIG. 3 shows a sectional view of the first plug connector with the first panel plug connector in the correctly mated state.

FIG. 4a shows a further sectional view of the first plug connector with the first panel plug connector in the correctly mated state.

FIG. 4b shows a sectional view of the second plug connector with the second panel plug connector in the correctly mated state.

FIG. 5a shows another sectional view of the second plug connector with the first panel plug connector in a mis-mated state.

FIG. 5b shows the first plug connector with the second panel plug connector in a mis-mated state in a further sectional view.

FIG. 6a shows another sectional view of the first plug connector with the second panel plug connector in the mis-mating plug-in process.

FIG. 6b again shows the first plug connector with the second panel plug connector in a mis-mated state.

Some of the Figures may contain simplified, schematic representations. In some cases, identical reference signs may be used for like but possibly not identical elements. Different views of the same elements may be scaled differently. Directional indications such as “left,” “right,” “top” and “bottom” are to be understood with reference to the respective Figure and may vary in the individual illustrations in relation to the object shown.

### DETAILED DESCRIPTION

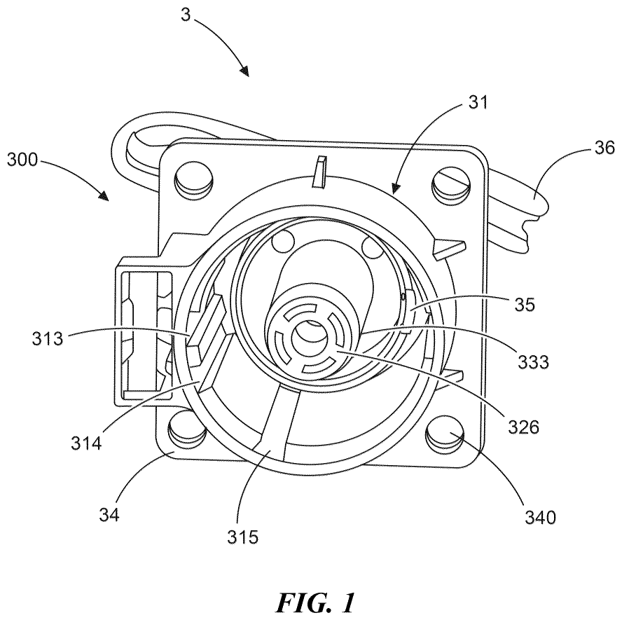

FIG. 1 shows a panel plug 3 corresponding to the prior art. The panel plug 3 has a panel housing 300 with a substantially hollow-cylindrical plug-in portion 31 and a panel flange 34. The panel flange 34 has four screw passages 340 for screwing to, for example, a battery or a housing of an accumulator pack or the like.

Several coding recesses 313, 314, 315 are arranged on an inside of the hollow-cylindrical plug-in portion 31. The coding recesses arrangement forms a coding. This coding prevents a plug not intended for this purpose (not shown) from being mated incorrectly with the panel plug. In addition, a predetermined rotational position of a plug corresponding to the prior art (not shown) is thereby predetermined during the mating process and in the mated state.

This determination of the rotational position of the plug not shown relative to the panel plug 3 is important because the panel plug 3 has an HV interlock connection 35 on the panel plug side at a point provided for this purpose in or on its plug-in portion 31.

A mating plug contact 333 with contact protection 326 is arranged in a center of the plug-in portion 31 of the panel plug 3. The mating plug contact 333 is used for plug-in connection with a plug contact of the plug to be plugged in (not shown).

This plug, which is not shown in the drawing, has a plug-side HV interlock connection which, when plugged in, makes electrical contact with the panel-plug-side HV interlock connection 35 of the panel plug 3. The plug-side HV interlock connection is located on the plug in a suitable position to make electrical contact with the HV interlock connection 35 on the panel plug side of the panel plug 3 when correctly mated. As a result, the correct mating state between the plug and the panel plug 3 can be automatically detected via a signal line 36 connected to the panel-plug-side interlock connection, e.g., in order to enable a subsequent, automatic switch-on of an electrical power supply, i.e., the power supply is only switched on when the correct mating state and thus the electrical connection is present as intended.

When the plug is removed, the plug-side HV interlock connection can be disconnected from the panel-plug-side HV interlock connection 35 “in advance,” i.e., the interlock connection is disconnected before the plug contact is disconnected from the mating plug contact 333. As a result, an electrical power supply can be switched off from the mating plug contact 333, e.g., via an electrical switch/relay (not shown), even before the plug contact is disconnected from the mating plug contact 333. This can prevent the formation of an electric arc. This protects the plug contact and the mating plug contact 333.

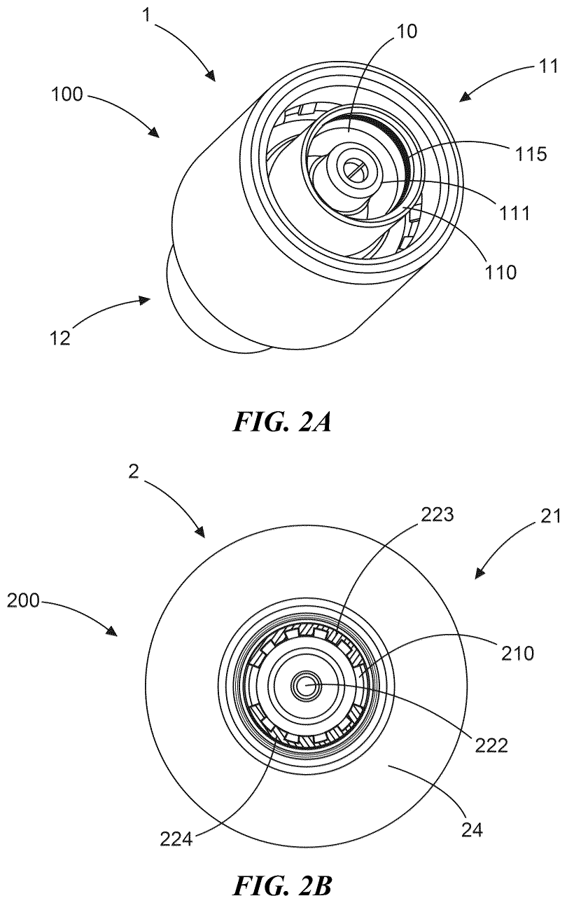

FIG. 2a shows a first plug connector 1. The first plug connector 1 has a plug connector housing 100 with a mating area 11 and a cable connection area 12 as well as a hollow-cylindrical insulating body 120, in which an electrical energy transfer contact 111 is arranged. Due to the hollow-cylindrical shape of the insulating body 120, a first cylindrical plug-in opening 10 is formed in its interior.

A circumferential first short-circuit bridge 115 is arranged in this plug-in opening 10 of the insulating body 110.

FIG. 2b shows a first panel plug connector 2 in the plug-in direction with a view of its mating area 21.

The first panel plug connector 2 has an add-on housing 200, comprising the mating area 21, in which a plug-in contact carrier 210 with a first mating contact 222 is arranged. Two signal contacts 223, 224, namely a first 223 and a second 224 signal contact, are arranged on the plug-in contact carrier 210. In addition, the add-on housing 200 has an add-on flange 24.

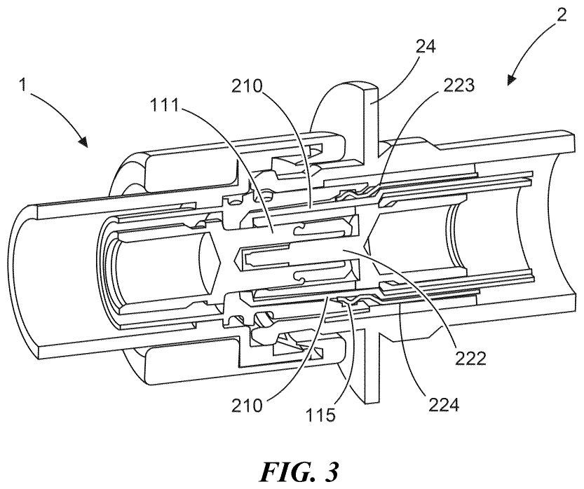

FIG. 3 shows the first plug connector 1 and the panel plug connector 2 in a correctly mated state in a perspective sectional view.

In addition to a push-pull latching mechanism known to a person skilled in the art, which ensures a correct mating state between the corresponding plug connectors 1, 1′ and panel plug connectors 2, 2′, and simultaneous internal and external contacting of the electrical power transmission contact 111 by the mating contact 222, the electrical short-circuiting of the two signal contacts 223, 224 by the first short-circuit bridge 115 is of importance in this case. This signals the correctly mated state in which the two plug connectors are located. When the first plug connector 1 is rotated relative to the panel plug connector 2, these signal contacts 223, 224 loop along the short-circuit bridge from the inside without ever losing their mutual electrically conductive connection.

This short circuit can be recognized by an electrical power distribution system. For example, an electrical switch/relay (not shown) connected to the signal contacts 223, 224 can be switched as a result. The switch/relay can, for example, electrically conductively connect the mating contact 222 of the panel plug connector 2 on the connection side to a first terminal of a battery (not shown).

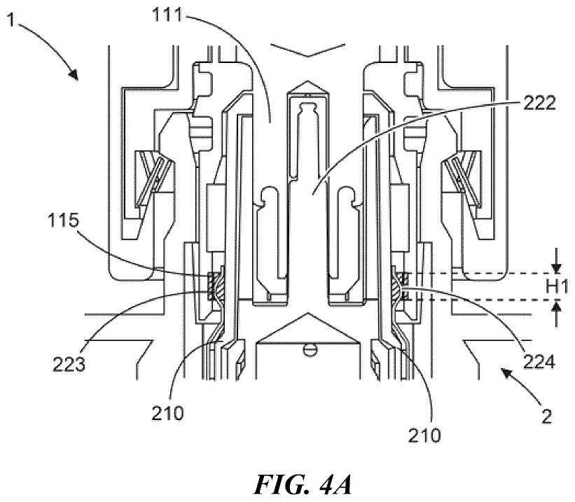

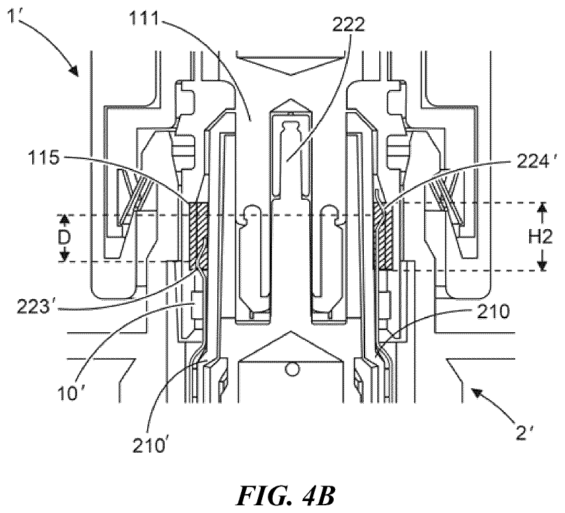

FIG. 4a shows the same arrangement in a slightly different view. It is easy to recognize in this illustration that the two signal contacts 223, 224 are at “one height” and are short-circuited by the first circumferential, hollow-cylindrical short-circuit bridge 115 in the correctly mated state shown, although it has a comparatively low height H1, which is shown vertically in the drawing.

In FIG. 4b, the second plug connector 1′ and the second panel plug connector 2′ are also shown correctly plugged together. The second plug connector 1′ differs from the first plug connector 1 only in the shape and position of the two signal contacts 223′, 224′, which are arranged on the plug contact carrier 210 with their unspecified contact areas offset by an offset D relative to each other. The second panel plug connector 2′ differs from the first panel plug connector 2 in a height H2 and position of its short-circuit bridge 115. Although the two contact areas are offset from each other by the offset D, the two signal contacts 223′, 224′ contact the second circumferential short-circuit bridge 115′ in a second plug-in opening 10′ at these respective contact areas and are short-circuited via it, i.e., a short-circuit signal is generated. The second plug-in connector 1′ can also be rotated about the mating axis relative to the second panel plug-in connector, wherein the associated signal contacts 223′, 224′ loop along the second short-circuit bridge 115 from the inside without losing electrical contact with one another, i.e., a short-circuit signal is generated.

This short-circuit signal can, for example, control the electrical switch/relay (not shown), which then closes and electrically connects the mating contact 222 on the cable connection side (shown here in the drawing at the bottom) to a terminal of a battery (not shown), i.e., automatically activates the electrical energy transfer in the present correctly mated state.

In an embodiment described herein in conjunction with the present disclosure, the two signal contacts 223, 224 of the first panel plug connector 2 can be electrically connected in series with the two signal contacts 223′, 224′ of the second panel plug connector 2′ in order to control the electrical switch/relay (not shown). The switch/relay then only closes when both signal contact pairs 223, 224/223′, 224′ are each short-circuited, i.e., when the first signal contact 223 of the first panel plug connector 2 is short-circuited to the second signal contact 224 of the first panel plug connector 2 and, in addition, the first signal contact 223′ of the second panel plug connector 2′ is short-circuited to the second signal contact 224′ of the second panel plug connector 2′.

Such a series connection can be realized as follows, for example: A first control connection of the control input of the electrical switch/relay (not shown) is electrically conductively connected to the first signal contact 223 of the first panel plug connector 2. The second signal contact 224 of the first panel plug connector 2 is electrically conductively connected to the first signal contact 223′ of the second panel plug connector 2′. The second signal contact 224′ of the second panel plug connector 2′ is electrically conductively connected to a second control connection of the control input of the electrical switch/relay (not shown).

The respective first control connection 223, 223′ is only electrically connected to the second control connection 224, 224′, i.e., forms a short circuit, when both plug connectors 1, 1′ are correctly mated with their corresponding panel plug connectors 2, 2′. The electrical switch/relay (not shown) then closes and connects its input to its output electrically conductively. This enables it to close a circuit for the electrical power supply, e.g., via an electrical load (not shown), which is thus supplied with electrical energy, e.g., from a battery/accumulator/accumulator pack (not shown).

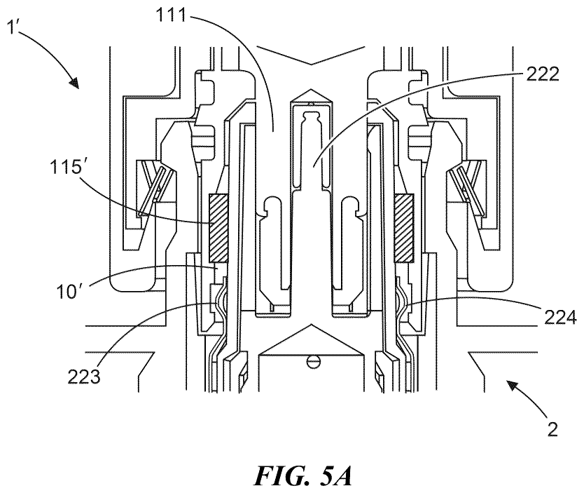

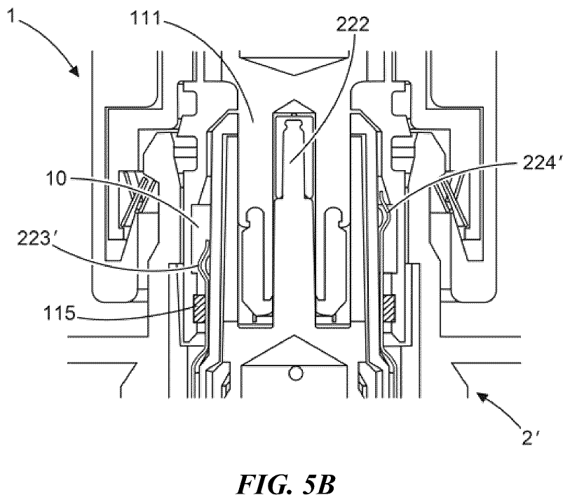

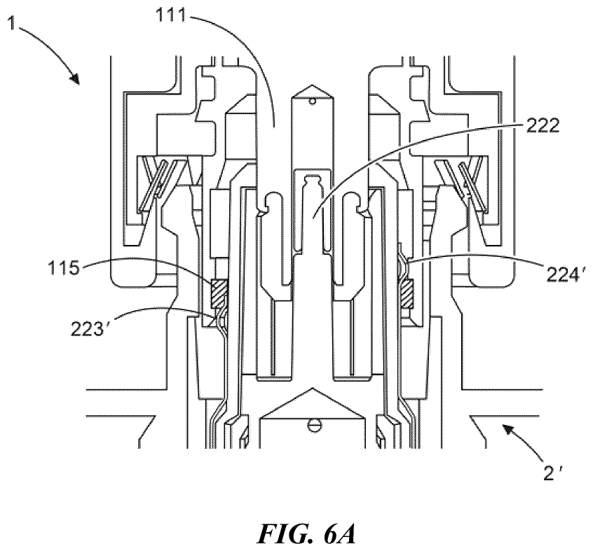

FIGS. 5a and 5b each show a mis-mating.

In FIG. 5a, the second plug connector 1′ is incorrectly plugged into the first panel plug connector 2, which is not intended for this purpose. The two signal contacts 223, 224 of the first panel plug connector 2 do not reach deep enough into the second plug-in opening 10′ of the second plug connector 1′ to be short-circuited. The mis-mating is therefore recognized and the aforementioned energy transfer would not be activated.

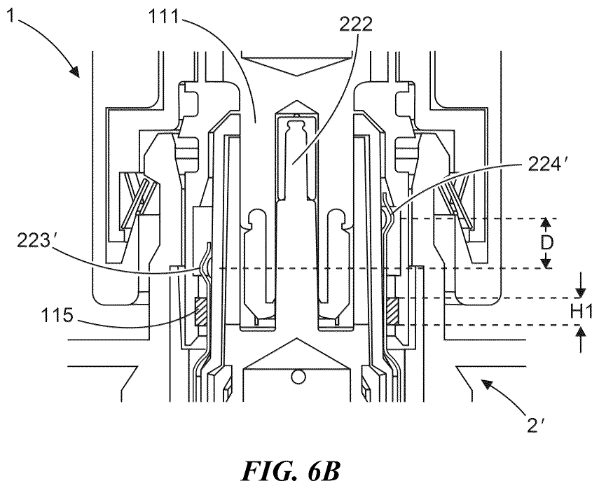

In FIG. 5b, the first plug connector 1 is incorrectly plugged into the second panel plug connector 2′, which is not intended for this purpose. On the one hand, the two signal contacts 223′, 224′ of the second panel plug connector 2′ extend too deeply into the plug-in opening 10 of the first plug connector 1 to be short-circuited. On the other hand, the two signal contacts 223′, 224′ offset D (see FIG. 6b) is also too large for them to contact the first short-circuit bridge 115 at the same time.

Ultimately, there is a fundamental risk here that a short circuit could otherwise occur between the signal contacts 223′, 224′ during the mating process.

FIG. 6a shows the mating process, i.e., the first plug connector 1 is being plugged into the second panel plug connector 2′. It can be seen that the two signal contacts 223′, 224′ of the second panel plug connector 2′ cannot be short-circuited via the first short-circuit bridge 115. This means that, even during the mating process, there is no mating position in which such a short circuit would be possible.

In FIG. 6b, it is shown as a reason in the mated state that the offset D is greater than a height H1 of the first short-circuit bridge 115.

The aforementioned energy transfer would therefore never be activated—not even temporarily—even in the event of this faulty connection.

German patent application no. 10 2023 124873.1, filed Sep. 14, 2023, to which this application claims priority, is hereby incorporated herein by reference, in its entirety.

Even if various aspects or features of the embodiments are shown in combination in the figures, it is apparent to a person skilled in the art—unless otherwise stated—that the combinations shown and discussed are not the only possible ones. In particular, corresponding units or feature complexes from different exemplary embodiments can be interchanged with one another. In other words, aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A plug connector system, comprising:
two plug connectors including a first and a second plug connector, wherein each plug connector has a mating area and a cable outlet;
two panel plug connectors including a first panel plug connector for plug-in electrical connection to the first plug connector in a first plug-in direction and corresponding to the first plug connector, and a second panel plug connector provided for plug-in electrical connection to the second plug connector in a second plug-in direction and corresponding to the second plug connector,
wherein the first and second plug connectors are configured to be mechanically plugged into the first and second panel plug connectors and can be electrically conductively connected in a mated state,
wherein a respective plug connector in the mated state can be rotated about an axis of rotation extending in the respective plug-in direction in various rotational positions and/or can be mated with the respective panel plug connector in a state rotated arbitrarily about a mating axis; and
an electrical coding system configured to signal clearly and independently of a respective rotational position thereof for each of the plug connectors whether the respective plug connector is correctly plugged in with the respective corresponding panel plug connector.

2. The plug connector system according to claim 1, wherein each of the plug connectors can be rotated through 360° to any desired rotational position when plugged in.

3. The plug connector system according to claim 1, wherein the plug connectors are angled so that a cable connection area has an outlet angle of between 5° and 95° to a mating axis of the mating area.

4. The plug connector system according to claim 1, wherein each of the plug connectors has an insulating body with an at least partially cylindrical plug-in opening, so that the first plug connector has a first cylindrical plug-in opening and the second plug connector has a second cylindrical plug-in opening, and wherein the electrical coding system has a circumferential electrically conductive short-circuit bridge arranged on an inside of each plug-in opening, namely a first short-circuit bridge in the first plug-in opening and a second short-circuit bridge in the second plug-in opening.

5. The plug connector system according to claim 4, wherein the plug connectors differ from one another substantially only in a shape and position of the respective short-circuit bridges in the respective plug-in openings.

6. The plug connector system according to claim 4, wherein each of the short-circuit bridges is designed to be hollow-cylindrical and has a cylinder axis, wherein each short-circuit bridge has a first height and a second height to be measured in the direction of the cylinder axis as well as a plug-side edge at a plug-side end and a cable-connection-side edge at a cable-connection-side end spaced apart from the plug-side edge by the first and second height.

7. The plug connector system according to claim 6, wherein the first height of the first short-circuit bridge is less than the second height of the second short-circuit bridge.

8. The plug connector system according to claim 6, wherein the plug-side edge of the second short-circuit bridge is arranged deeper in the plug-in opening of the second plug connector than the plug-side edge of the first short-circuit bridge in the plug-in opening of the first plug connector.

9. The plug connector system according to claim 6, wherein the electrical coding system has two signal contacts for each panel plug connector in order to clearly signal to a connected power distribution system by a short circuit of the two signal contacts occurring via the respective short-circuit bridge whether the panel plug connector is correctly mated with the panel plug connector's corresponding plug connector.

10. The plug connector system according to claim 9, wherein the two signal contacts of the second built-in plug connector are arranged offset relative to one another in the second plug-in direction on a mating area of the second panel plug connector.

11. The plug connector system according to claim 9, wherein the two signal contacts of the second panel plug connector are arranged offset in the second plug-in direction by more than the first height of the first short-circuit bridge on the mating area of the second panel plug connector.

12. The plug connector system according to claim 9, wherein the two signal contacts of the first panel plug connector are not arranged at all in the first plug-in direction or are arranged offset from each other at most by the first height of the first short-circuit bridge on the mating area of the first panel plug connector.

13. The plug connector system according to claim 9, wherein in the mis-mated state none—or at most only one—of the signal contacts arranged in the first panel plug connector extends into the second plug connector mis-mated with the first built-in plug connector in order to make electrical contact with the second short-circuit bridge.

14. The plug connector system according to claim 1, wherein each plug connector is of single-terminal design and has one electrical power transmission contact.

15. An energy distribution system, comprising:
a plug connector system including a first and a second plug connector, and a first and a second panel plug connector;
a battery or a battery system with two terminals, namely a positive terminal and a negative terminal;
two electrical power transmission cables; and
at least one electrically switchable electrical switch, having an input, an output and a control input,
wherein the electrical switch is configured to electrically conductively connect or disconnect the output of the electrical switch to or from the input of the electrical switch in accordance with an electrical signal applied to the control input of the electrical switch,
wherein the input of the electrical switch is electrically conductively connected to one of the terminals of the battery,
wherein at least one panel plug connector is connected on a connection side to the output of the at least one electrical switch, and
wherein each of the plug connectors is connected on a cable connection side to one of the electrical power transmission cables, and
wherein the power distribution system is configured to close the at least one electrical switch when the electrical coding system signals that each panel plug connector is correctly mated with a respective corresponding plug connector of the panel plug connector.
